(19) United States
(12) Patent Application Publication
(10) Pub. No.: US 2012/0105808 A1
(43) Pub. Date: May 3, 2012

(54) VEHICLE DISPLAY SYSTEM

(75) Inventors: Fei Feng, Shanghai (CN); Peter G. Diehl, Shanghai (CN)

(73) Assignee: GM GLOBAL TECHNOLOGY OPERATIONS, INC., Detroit, MI (US)

(21) Appl. No.: 12/913,901

(22) Filed: Oct. 28, 2010

(51) Int. Cl. G03B 21/14

(52) U.S. Cl. 353/20

(57) ABSTRACT

A device for a vehicle that includes an at least partially transparent member operatively connected to the vehicle, the at least partially transparent member having a first side and a second side. A projector emits electromagnetic radiation projecting an image on or in the at least partially transparent member. A first polarizer is positioned on the first side of the transparent member such that the electromagnetic radiation goes through the first polarizer. A second polarizer is positioned on the second side of the at least partially transparent member. The first polarizer and the second polarizer are oriented such that the image is visible from the first side of the at least partially transparent member and not visible from the second side of the at least partially transparent member. The second polarizer may have a second polarization axis that is substantially orthogonal to a first polarization axis of the first polarizer.

### TECHNICAL FIELD

This invention relates in general to a vehicle display system.

### BACKGROUND

A vehicle display system may be utilized in a vehicle to display data or images for the driver or passengers in the vehicle. However, if an image is displayed on a part like the front windshield, it can be seen from both the interior and exterior of the vehicle.

### SUMMARY

A device for a vehicle that includes an at least partially transparent member operatively connected to the vehicle, the at least partially transparent member having a first side and a second side. A projector emits electromagnetic radiation projecting an image on or in the at least partially transparent member. A first polarizer is positioned on the first side of the transparent member such that the electromagnetic radiation goes through the first polarizer. A second polarizer is positioned on the second side of the at least partially transparent member. The first polarizer and the second polarizer are oriented such that the image is visible from the first side of the at least partially transparent member and not visible from the second side of the at least partially transparent member. The second polarizer may have a second polarization axis that is substantially orthogonal to a first polarization axis of the first polarizer.

The first side of the at least partially transparent member may face the inside of the vehicle and the second side of the at least partially transparent member may face the outside of the vehicle. The at least partially transparent member may be substantially transparent. A third polarizer may be operatively connected to the second side of the at least partially transparent member, to control the transmission of exterior light into the vehicle. The first and second polarizers may be linear polarizers. The first and second polarizers may be circular polarizers. The first polarizer may be a linear polarizer and the second polarizer may be a circular polarizer, and vice-versa. A quarter wave plate may be positioned between the first polarizer and the second polarizer to convert the electromagnetic radiation from linearly polarized to circularly polarized, and vice-versa.

A plurality of light emitting particles may be integrated in the at least partially transparent member. The light emitting particles emit visible light in response to absorbing the electromagnetic radiation from the projector, forming the image on or in the transparent member.

The electromagnetic radiation may include a first and second wavelength range, with the first wavelength range being different from the second wavelength range. The at least partially transparent member may include a first layer having at least one first light emitting particle that emits a first visible color upon absorbing electromagnetic radiation in the first wavelength range. The at least partially transparent member may include a second layer having at least one second light emitting particle that emits a second visible color upon absorbing electromagnetic radiation in the second wavelength range. The second visible color may be different from the first visible color. The image may be formed on or in the at least partially transparent member by the combination of the first visible color and the second visible color.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic exploded fragmentary perspective view of a device for a vehicle in accordance with one embodiment;

FIG. 2 is a schematic exploded fragmentary perspective view of the device shown in FIG. 1, illustrating the path of exterior light incident on the vehicle;

FIG. 3 is a schematic fragmentary perspective view of a vehicle having the device of FIG. 1;

FIG. 4 is a schematic exploded perspective view of a transparent member included in the device of FIG. 1; and

FIG. 5 is a schematic perspective view of the transparent member shown in FIG. 5.

### DETAILED DESCRIPTION

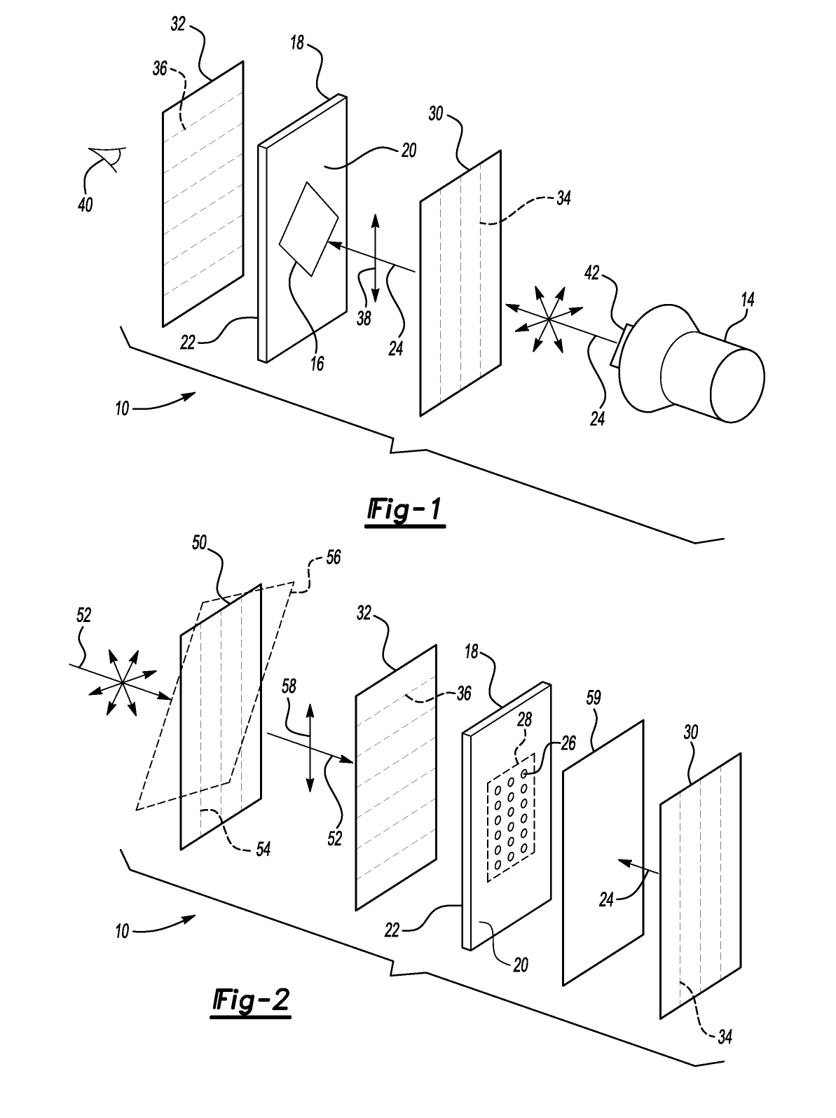

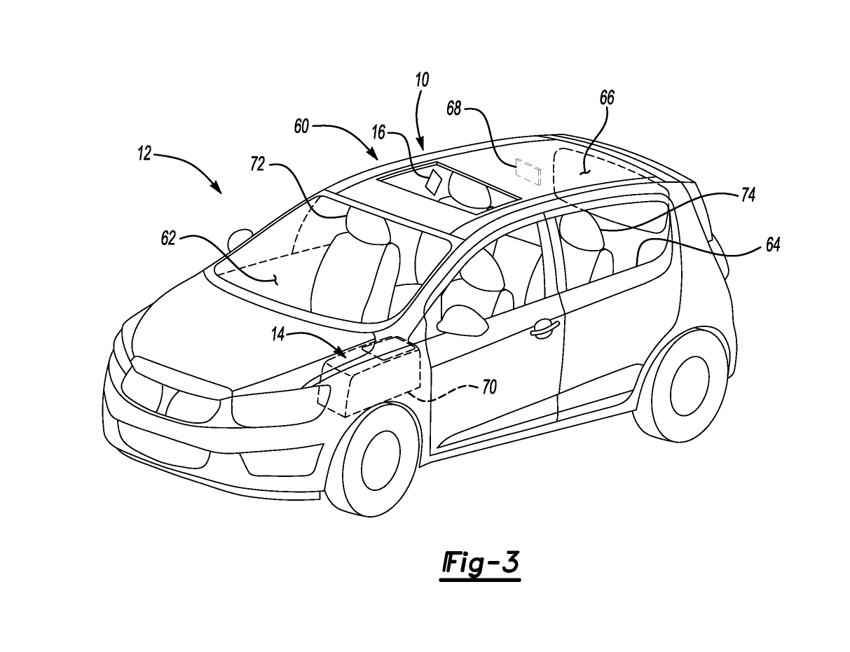

A device for a vehicle is provided in which an image is formed on or in a transparent member in the vehicle, where the image is visible to a human eye or sensor from a first side of the transparent member and is not visible to a human eye or sensor from a second side of the transparent member. FIGS. 1 and 2 are schematic fragmentary perspective exploded views of a device 10 in accordance with one embodiment. FIG. 3 is a schematic fragmentary perspective view of a vehicle 12 having the device 10. As shown in FIG. 1, a projector 14 projects an image 16 onto an at least partially transparent member 18, such as a window or windshield, operatively connected to a vehicle. The image 16 is visible from a first side 20 of the transparent member 18 and not visible from a second side 22 of the transparent member 18. The first side 20 of the transparent member 18 may face the inside of the vehicle and the second side 22 of the transparent member 18 may face the outside of the vehicle. For example, if an image of the borders of the road at night time was projected onto the front windshield of the vehicle, the image would be visible from the interior of the vehicle (first side 20) and not visible from the exterior of the vehicle (second side 22).

The transparent member 18 is at least partially transparent in that it allows at least some light incident on its surface to pass through. In one embodiment, the transparent member 18 is a substantially transparent member, in that it allows most of the light falling incident on it to pass through. For example, the substantially transparent member may be glass. In another embodiment, the transparent member 18 is only partially transparent in that it allows only a small fraction of light falling on it to pass through. For example, an only partially transparent member may be an acrylic sheet, polymer sheet, vinyl sheet, color acrylic board, ground glass sheet or black painted glass.

The projector 14 emits electromagnetic radiation 24, shown in FIG. 1. A plurality of light emitting particles 26 (shown in FIG. 2) may be integrated on or in the transparent member 18. The light emitting particles 26 may be embedded, dispersed, coated on, attached or integrated in any other suitable manner on or in the transparent member 18. The light emitting particles 26 each emit visible light in response to absorbing the electromagnetic radiation 24 from the projector 14 (shown in FIG. 1). The emitted visible light forms or creates the image 16 on or in the transparent member 18, shown in FIG. 1. The image 16 is generally formed in the transparent member 18 when the light emitting particles 26 are embedded or dispersed within the transparent member 18. The image 16 is generally formed on the transparent member 18 when the light emitting particles 26 are coated or attached onto the transparent member 18. The light emitting particles 26 may be integrated in the entire transparent member 18 or a display portion 28 of the transparent member 18. Each of the light emitting particles 26 may have a diameter less than about 500 nanometers. Any other suitable method of projecting an image in or on the transparent member 18 may also be used.

As shown in FIG. 1, the device 10 includes a first polarizer 30 positioned in such a way that the electromagnetic radiation 24 from the projector 14 goes through the first polarizer 30. A second polarizer 32 may be operatively connected to the second side 22 of the transparent member 18. FIG. 1 shows the relative positions of the first polarizer 30, the transparent member 18 and the second polarizer 32. The first polarizer 30 has a first polarization axis 34. The second polarizer 32 has a second polarization axis 36, which is approximately 90 degrees or orthogonal to the first polarization axis 34 of the first polarizer 30.

The electromagnetic radiation 24 from the projector 14 is generally unpolarized, with all planes of propagation being equally probable. Polarization refers to the orientation of the electric field of an electromagnetic wave. As the electromagnetic radiation 24 passes through the first polarizer 30, it becomes polarized in a first orientation 38 parallel or similar to the first polarization axis 34. Any portion of this polarized electromagnetic radiation 24 that is unabsorbed by the transparent member 18 and incident on the second polarizer 32 is extinguished. This is because the first polarization axis 34 is approximately orthogonal to the second polarization axis 36. The second polarizer 32 is positioned such that any emitted visible light (which forms the image 16) exiting the transparent member 18 is incident on the second polarizer 32 and is extinguished. Thus the electromagnetic radiation 24 and the image 16 are not visible to a sensor or observer 40 on the second side 22 of the transparent member.

The first polarizer 30 may be in the form of a film. The film may be coated or attached to the top surface of the lens 42 of the projector. The first polarizer 30 may also be in the form of a plate or sheet placed in the path of the electromagnetic radiation 24 from the projector 14. The second polarizer 32 may be in the form of a film or sheet that is pasted with an adhesive or coated onto the transparent member 18.

In one embodiment, the projector 14 may emit ultraviolet light. In another embodiment, the projector 14 may emit infrared light. In another embodiment, the projector 14 may emit visible light. The wavelength of the electromagnetic radiation 24 emitted by the projector 14 is different from the wavelength of the emitted visible light. A laser may be used instead of a projector.

Optionally, a third polarizer 50 (shown in FIG. 2) may be used to vary the amount of light entering the vehicle 12 (shown in FIG. 3) from sources exterior to the vehicle 12. For example, bright sunlight may be minimized from interfering with the image 16 displayed on or in the transparent member 18 (shown in FIG. 1). FIG. 2 illustrates the path of the exterior light 52. The third polarizer 50 may be positioned on the second side of the transparent member 18, adjacent to the second polarizer 32. The third polarizer 50 has a third polarization axis 54. The third polarizer 50 may be in the form of a film or sheet that is operatively connected to the transparent member 18.

The transmitted intensity of the exterior light 52 may be calculated as described herein. As the exterior light 52 passes through the third polarizer 50 it is polarized in a third orientation 58 parallel to the third polarization axis 54. When the third polarization axis 54 is at an angle of θ with respect to the second polarization axis 36 (of the second polarizer 32), the vector component perpendicular to its transmission plane is absorbed, reducing its amplitude to a factor of (cos θ) of the incident amplitude. Since the transmitted intensity is proportional to the amplitude squared, the intensity is given by a factor of (cos θ) squared of the incident intensity. In FIG. 2, the angle θ is 90 degrees as the third polarization axis 54 is approximately 90 degrees with respect to the second polarization axis 36; thus the transmitted intensity of the exterior light 52 is zero. When the third polarizer 50 is rotated to a different position 56 (shown in phantom) with respect to the second polarizer 32, the angle θ changes. For example, when θ is 30 degrees, the transmitted intensity is 75%. When θ is 60 degrees, the transmitted intensity is 25%. Thus the intensity of the exterior light 52 that is transmitted into the vehicle 12 may be varied by changing the orientation of the third polarization axis 54 with respect to the second polarization axis 36.

Optionally, the first polarizer 30 and the second polarizer 32 may both be linear polarizers. Optionally, the first polarizer 30 and the second polarizer 32 may both be circular polarizers. A linear polarizing filter allows only waves that are oriented a certain way to pass through. Linear polarization is defined as the electric field vector oscillating in a single plane. Circular polarization is defined as a combination of two perpendicular linear waves that are 90 degrees out of phase with each other.

Optionally, a combination of a linear polarizer and a circular polarizer may be employed. In this case, a quarter wave plate 59 (shown in FIG. 2) may be placed between the first polarizer and the second polarizer to convert linearly polarized radiation into circularly polarized radiation and vice versa. For example, the first polarizer 30 may be a linear polarizer and the second polarizer 32 may be a circular polarizer. The electromagnetic radiation 24 passes though the first polarizer (linear polarizer in this example) which allows only one linear polarization to pass. The quarter wave plate 59 converts linearly polarized radiation into circularly polarized radiation, which is subsequently extinguished by the second polarizer (circular polarizer in this example).

FIG. 3 is a schematic fragmentary perspective view of a vehicle 12 having the device 10. As shown in FIG. 3, the image 16 is displayed on or in the sunroof 60 of the vehicle 12. The projector 14 may be located at a center armrest 70, shown in phantom in FIG. 3. The transparent member 18 for displaying the image may be the front windshield 62, a side window 64 or the rear windshield 66. The transparent member 18 may also be a monitor 68 placed in the vehicle 12. Optionally, the projector 14 may be located at a front passenger headrest 72 for projecting onto the front windshield 62. Optionally, the projector 14 may be located at a rear passenger headrest 74 for projecting onto the sunroof 60. Any suitable location for the projector 14 may be employed.

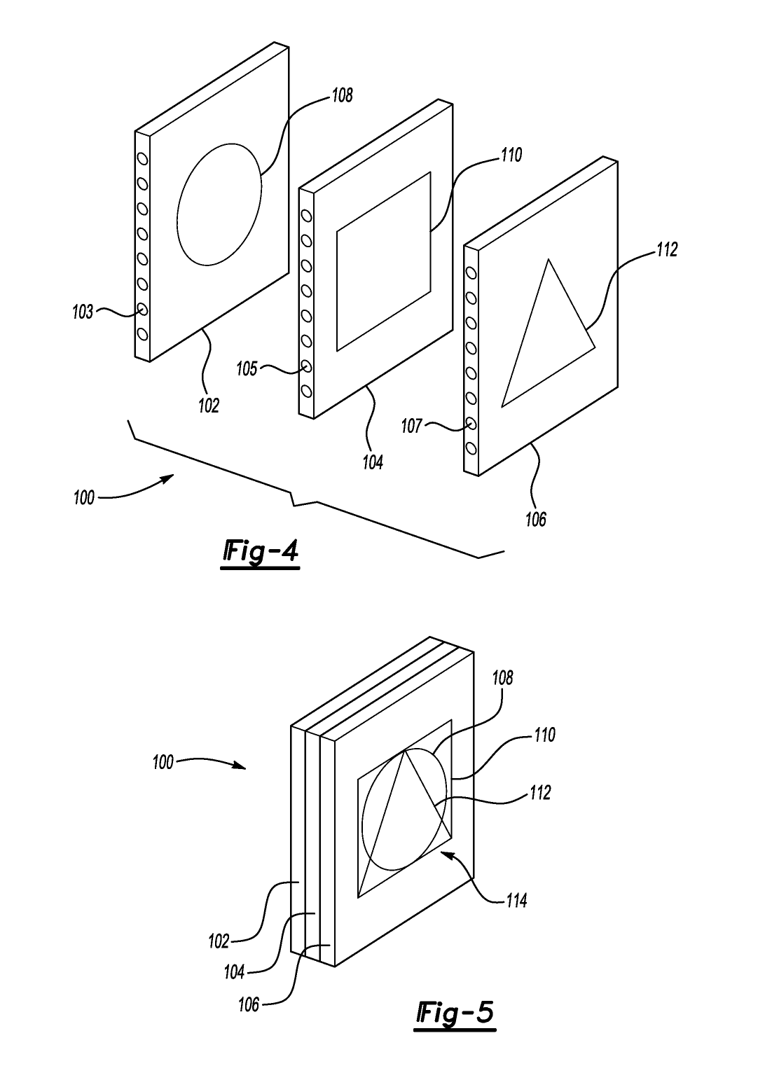

Optionally, the transparent member may be made up of a plurality of layers of light emitting material, with each layer emitting a different color visible light upon absorption of electromagnetic radiation 24 from the projector 14. FIG. 4 is a schematic exploded perspective view of a multi-layer transparent member 100. FIG. 5 is a schematic perspective view of the multi-layer transparent member 100 shown in FIG. 4. As shown in FIG. 4, the transparent member 100 may include a first layer 102 having at least one first light emitting particle 103 emitting a first visible color upon absorption of electromagnetic radiation 24. The transparent member 100 may include a second layer 104 having at least one second light emitting particle 105 emitting a second visible color upon absorption of electromagnetic radiation 24. The transparent member 100 may include a third layer 106 having at least one third light emitting particle 107 emitting a third visible color upon absorption of electromagnetic radiation 24. The first, second and third visible colors may be different from each other. In this example, the first, second and third visible colors are blue, green and red, respectively.

The projector 14 may be adapted to produce electromagnetic radiation 24 having at least two different wavelength ranges. Each wavelength range may excite a corresponding layer of the transparent member 100 to emit visible light which is viewable on or in the transparent member 100. The electromagnetic radiation 24 may be composed of a first, second and third wavelength range. For example, the first wavelength range may be about 380 nanometers to about 400 nanometers; the second wavelength range may be about 400 nanometers to about 430 nanometers; and the third wavelength range may be about 430 nanometers to about 460 nanometers. Any suitable range may be used. Each wavelength range may project a separate sub-image.

In the example shown in FIGS. 4 and 5, electromagnetic radiation from the first, second and third wavelength ranges project an image of a circle 108, square 110 and triangle 112, respectively. The first layer 102 absorbs electromagnetic radiation from the first wavelength range, creating an image of a blue circle 108. The second layer 104 absorbs electromagnetic radiation from the second wavelength range, creating an image of a green square 110. The third layer 106 absorbs electromagnetic radiation from the third wavelength range, creating an image of a red triangle 112. The overall image 114 created is a blue circle 108 interposed over a green square 110 and a red triangle 112. Other combinations of colors may also be used. Any number of layers may be used.

The first, second and third light emitting particles 103, 105, 107 may be fluorescent particles or molecules. The light emitting particles 26 described above may be fluorescent particles or molecules. Examples of fluorescent particles emitting different colors include praseodymium (red), terbium (green), thulium (blue), dysprosium (yellow), willemite (green), wollastonite (orange), clinohedrite (orange), andersonite (yellow green), autunite (yellow green), europium (blue), powellite (yellow) and scheelite (blue). The size of the particles may be smaller than the wavelength of visible light, to reduce or eliminate visible light scattering by the particles. Each of the light emitting particles 26 may have a diameter less than about 500 nanometers. The light emitting particles may be metallic, polymeric, pure organic or organo-metallic dyes or any other suitable material.

While the best modes for carrying out the invention have been described in detail, those familiar with the art to which this invention relates will recognize various alternative designs and embodiments for practicing the invention within the scope of the appended claims.

1. A device for a vehicle comprising:
an at least partially transparent member operatively connectable to a vehicle, the at least partially transparent member having a first side and a second side;
a projector emitting electromagnetic radiation, the electromagnetic radiation projecting an image on or in the at least partially transparent member;
a first polarizer positioned on the first side of the transparent member such that the electromagnetic radiation goes through the first polarizer;
a second polarizer positioned on the second side of the at least partially transparent member;
wherein the first polarizer and the second polarizer are oriented such that the image is visible from the first side of the at least partially transparent member and not visible from the second side of the at least partially transparent member.

2. The device of claim 1:
wherein the first polarizer has a first polarization axis; and
wherein the second polarizer has a second polarization axis that is substantially orthogonal to the first polarization axis.

3. The device of claim 2, wherein the first side of the at least partially transparent member faces inside of the vehicle and the second side of the at least partially transparent member faces outside of the vehicle.

4. The device of claim 2, wherein the at least partially transparent member is substantially transparent.

5. The device of claim 2, further comprising a third polarizer operatively connected to the second side of the at least partially transparent member, to control the transmission of exterior light into the vehicle.

6. The device of claim 2:
wherein the first polarizer is a linear polarizer; and
wherein the second polarizer is a linear polarizer.

7. The device of claim 2:
wherein the first polarizer is a circular polarizer; and
wherein the second polarizer is a circular polarizer.

8. The device of claim 2, wherein the at least partially transparent member is a front windshield of the vehicle.

9. The device of claim 2, wherein the at least partially transparent member is a sunroof of the vehicle.

10. The device of claim 2, wherein the at least partially transparent member is a rear windshield of the vehicle.

11. The device of claim 2, wherein the at least partially transparent member is a side window of the vehicle.

12. The device of claim 2, wherein the electromagnetic radiation is ultraviolet light.

13. The device of claim 2, wherein the electromagnetic radiation is infrared light.

14. The device of claim 2, wherein the electromagnetic radiation is visible light.

15. The device of claim 2, wherein the projector is located at a center armrest.

16. The device of claim 2, wherein the projector is positioned at a front passenger headrest.

17. The device of claim 2, further comprising:
a plurality of light emitting particles integrated in the at least partially transparent member;
wherein the plurality of light emitting particles emit visible light in response to absorbing the electromagnetic radiation from the projector, the emitted visible light forming the image on or in the at least partially transparent member.

18. The device of claim 17, wherein each of the plurality of light emitting particles has a diameter less than about 500 nanometers.

19. A device for a vehicle comprising:
a projector emitting electromagnetic radiation;
wherein the electromagnetic radiation includes a first and second wavelength range, the first wavelength range being different from the second wavelength range;
a first polarizer positioned such that the electromagnetic radiation goes through the first polarizer, the first polarizer having a first polarization axis;
an at least partially transparent member operatively connectable to a vehicle, the at least partially transparent member including:
a first layer having at least one first light emitting particle emitting a first visible color upon absorbing electromagnetic radiation in the first wavelength range;
a second layer having at least one second light emitting particle emitting a second visible color upon absorbing electromagnetic radiation in the second wavelength range, the second visible color being different from the first visible color;
an image formed on or in the at least partially transparent member by the first visible color and the second visible color;
a second polarizer operatively connected to the at least partially transparent member, the second polarizer having a second polarization axis that is substantially orthogonal to the first polarization axis; and
wherein the image is visible from a first side of the at least partially transparent member and not visible from a second side of the at least partially transparent member.

20. The device of claim 19:
wherein the electromagnetic radiation includes a third wavelength range, the third wavelength range being different from the first and the second wavelength ranges;
wherein the at least partially transparent member includes a third layer having at least one third light emitting particle emitting a third color light upon absorbing electromagnetic radiation in the third wavelength range;
wherein the image formed includes the third color light.
